(19) United States
(12) Patent Application Publication
(10) Pub. No.: US 2020/0396120 A1
(43) Pub. Date: Dec. 17, 2020

(54) METHODS, DEVICES AND COMPUTER-READABLE MEDIUMS FOR NETWORK DEVICE ALARM NOTIFICATIONS

(71) Applicant: Nokia Solutions and Networks OY, Espoo (FI)

(72) Inventor: Frederic GUILBEAULT, Ontario (CA)

(73) Assignee: Nokia Solutions and Networks OY, Espoo (FI)

(21) Appl. No.: 16/440,412

(22) Filed: Jun. 13, 2019

(51) Int. Cl. H04L 12/24; G06F 9/455

(52) U.S. Cl. CPC H04L 41/0672; H04L 41/0686; G06F 2009/45595; G06F 9/45558; H04L 41/069

(57) ABSTRACT

A method for generating alarm notifications in a network, comprises: identifying a stateful alarm object instance linked to a primitive event from a network device of a first type, the stateful alarm object instance based on an alarm configuration for an alarm type associated with the network device of a first type; determining that the primitive event results in a state transition in a state machine for the stateful alarm object instance linked to the primitive event from the network device of a first type; deciding whether to generate an alarm in response to the state transition; and selectively generating the alarm based on the deciding step.

### BACKGROUND

Network management involves monitoring physical or virtual network devices over time. In one example, network management is used to detect and report faults in a network via alarms. Alarms may be managed using a network management application.

### SUMMARY

One or more example embodiments provide an alarm logic configured to flag alarm-able conditions at network devices (also referred to as network device instances) based on primitive event notifications (primitive events) from the network devices, and selectively generate corresponding alarms northbound. The alarm logic may be implemented as a Virtual Network Function (VNF) at a data center or in the cloud, rather than at each individual network device.

One or more example embodiments may improve configure-ability network-wide since the VNF may be readily and/or dynamically configurable at a central location, and/or may be reconfigured on-the-fly.

One or more example embodiments may also provide more efficient use of network device resources by reducing overhead per network device, given that the alarm logic is relocated from the network device itself to a centralized location (or locations).

One or more example embodiments may enable analytics at a data center or centers based on the collected primitive events data from all network devices. The analytics may be used to improve and/or optimize alarm configurations at the VNF.

One or more example embodiments may alleviate the need for network devices to autonomously generate alarms (also referred to herein as alarm notifications) northbound for the purposes of, for example, network fault detection and/or correction, over time. Overhead at the network devices may also be reduced since the network devices need not run logic required to generate alarms, which may decrease the cost of each network device.

One or more example embodiments may also reduce errors and/or labor required to configure how alarms are generated across a relatively large network.

One or more example embodiments may increase alarm configuration flexibility by enabling alarm correlation and/or aggregation across network device instances of the same or different types, or groups thereof. At least one example embodiment provides a method for generating alarm notifications in a network, the method comprising: identifying a stateful alarm object instance linked to a primitive event from a network device of a first type, the stateful alarm object instance based on an alarm configuration for an alarm type associated with the network device of a first type; determining that the primitive event results in a state transition in a state machine for the stateful alarm object instance linked to the primitive event from the network device of a first type; deciding whether to generate an alarm in response to the state transition; and selectively generating the alarm based on the deciding step.

At least one other example embodiment provides a non-transitory computer-readable storage medium storing computer-readable instructions that, when executed by at least one processor at a network device, cause the network device to perform a method for generating alarm notifications in a network, the method comprising: identifying a stateful alarm object instance linked to a primitive event from a network device of a first type, the stateful alarm object instance based on an alarm configuration for an alarm type associated with the network device of a first type; determining that the primitive event results in a state transition in a state machine for the stateful alarm object instance linked to the primitive event from the network device of a first type; deciding whether to generate an alarm in response to the state transition; and selectively generating the alarm based on the deciding step.

According to one or more example embodiments, the primitive event may be indicative of a fault event at the network device of a first type, and the alarm may trigger resolving of the fault event.

The deciding step may include: determining that the alarm type is externally visible based on the alarm configuration; determining that the stateful alarm object instance does not include a delay; and wherein the selectively generating generates the alarm in response to determining that the alarm type is externally visible and that the stateful alarm object instance does not include a delay.

The identifying may include parsing the primitive event received from the network device of a first type to identify the stateful alarm object instance linked to the primitive event.

The method may further include recording the primitive event and result of the state transition in an alarm log.

At least one other example embodiment provides a network device to generate alarm notifications in a network, the network device comprising: at least one processor and at least one memory including computer program code. The at least one memory and the computer program code are configured to, with the at least one processor, cause the network device to: identify a stateful alarm object instance linked to a primitive event from a network device of a first type, the stateful alarm object instance based on an alarm configuration for an alarm type associated with the network device of a first type; determine that the primitive event results in a state transition in a state machine for the stateful alarm object instance linked to the primitive event from the network device of a first type; decide whether to generate an alarm in response to the state transition; and selectively generate the alarm based on the deciding step.

At least one other example embodiment provides a network device to generate alarm notifications in a network, the network device comprising: means for identifying a stateful alarm object instance linked to a primitive event from a network device of a first type, the stateful alarm object instance based on an alarm configuration for an alarm type associated with the network device of a first type; means for determining that the primitive event results in a state transition in a state machine for the stateful alarm object instance linked to the primitive event from the network device of a first type; means for deciding whether to generate an alarm in response to the state transition; and means for selectively generating the alarm based on the decision by the means for deciding step.

According to one or more example embodiments, the primitive event may be indicative of a fault event at the network device of a first type, and the alarm may trigger resolving of the fault event.

The at least one memory and the computer program code may be configured to, with the at least one processor, cause the network device to: decide whether to generate the alarm in response to the state transition by determining that the alarm type is externally visible based on the alarm configuration, and determining that the stateful alarm object instance does not include a delay; and generate the alarm in response to determining that the alarm type is externally visible and that the stateful alarm object instance does not include a delay.

The at least one memory and the computer program code may be configured to, with the at least one processor, cause the network device to parse the primitive event received from the network device to identify the stateful alarm object instance linked to the primitive event.

The at least one memory and the computer program code may be configured to, with the at least one processor, cause the network device to record the primitive event and result of the state transition in an alarm log in the memory.

At least one other example embodiment provides a method for generating alarm notifications in a network, the method comprising: identifying a stateful alarm object instance linked to other stateful alarm object instances for a network device of a first type in response to a received state transition notification event; determining that the received state transition notification event results in a state transition in a state machine for the network device of a first type; deciding whether to generate an alarm in response to the state transition; and selectively generating the alarm based on the deciding step.

At least one other example embodiment provides a network device to generate alarm notifications in a network, the network device comprising: at least one processor and at least one memory including computer program code. The at least one memory and the computer program code are configured to, with the at least one processor, cause the network device to identify a stateful alarm object instance linked to other stateful alarm object instances for a network device of a first type in response to a received state transition notification event; determine that the received state transition notification event results in a state transition in a state machine for the network device of a first type; decide whether to generate an alarm in response to the state transition; and selectively generating the alarm based on the deciding.

At least one other example embodiment provides a network device to generate alarm notifications in a network, the network device comprising: means for identifying a stateful alarm object instance linked to other stateful alarm object instances for a network device of a first type in response to a received state transition notification event; means for determining that the received state transition notification event results in a state transition in a state machine for the network device of a first type; means for deciding whether to generate an alarm in response to the state transition; and means for selectively generating the alarm based on the decision by the means for deciding.

At least one other example embodiment provides a non-transitory computer-readable storage medium storing computer-readable instructions that, when executed by at least one processor at a network device, cause the network device to perform a method for generating alarm notifications in a network, the method comprising: identifying a stateful alarm object instance linked to other stateful alarm object instances for a network device of a first type in response to a received state transition notification event; determining that the received state transition notification event results in a state transition in a state machine for the network device of a first type; deciding whether to generate an alarm in response to the state transition; and selectively generating the alarm based on the deciding step.

The received state transition notification event may be indicative of at least one fault event at the network device of a first type, and the alarm may trigger resolving of the at least one fault event.

At least one other example embodiment provides a method for configuring a device to identify alarm conditions at devices in a network, the method comprising: obtaining a set of network entity instances from a network data store based on network entity types specified in an alarm configuration for a first network device type; instantiating, in a memory, a stateful alarm object instance for each network entity instance in the set of network entity instances; and listening for primitive events from network devices in the network.

At least one other example embodiment provides a network device to generate alarm notifications in a network, the network device comprising: at least one processor and at least one memory including computer program code. The at least one memory and the computer program code are configured to, with the at least one processor, cause the network device to obtain a set of network entity instances from a network data store based on network entity types specified in an alarm configuration for a first network device type; instantiate, in a memory, a stateful alarm object instance for each network entity instance in the set of network entity instances; and listen for primitive events from network devices in the network.

At least one other example embodiment provides a non-transitory computer-readable storage medium storing computer-readable instructions that, when executed by at least one processor at a network device, cause the network device to perform a method for configuring a device to identify alarm conditions at devices in a network, the method comprising: obtaining a set of network entity instances from a network data store based on network entity types specified in an alarm configuration for a first network device type; instantiating, in a memory, a stateful alarm object instance for each network entity instance in the set of network entity instances; and listening for primitive events from network devices in the network.

At least one other example embodiment provides a network device to generate alarm notifications in a network, the network device comprising: means for obtaining a set of network entity instances from a network data store based on network entity types specified in an alarm configuration for a first network device type; means for instantiating, in a memory, a stateful alarm object instance for each network entity instance in the set of network entity instances; and means for listening for primitive events from network devices in the network.

The method may further include: generating the alarm configuration for the first network device type; and loading the alarm configuration for the first network device type onto the device.

The method may further include: deciding whether to generate an alarm in response to a primitive event from a network device based on a stateful alarm object instance for a corresponding network entity instance in the set of network entity instances; and selectively generating the alarm based on the deciding step. The primitive event may be indicative of a fault event at the network device of a first type, and the alarm triggers resolving of the fault event.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a simple network diagram illustrating a centralized device implementing an alarm virtualized network function (VNF) according to example embodiments.

FIG. 2 is a flow chart illustrating a method according to example embodiments.

FIG. 3 is a flow chart illustrating another method according to example embodiments.

FIG. 4 is a flow chart illustrating another method according to example embodiments.

FIG. 5 is a block diagram illustrating a network management database system according to example embodiments.

FIG. 6 is a flow chart illustrating another method according to example embodiments.

FIG. 7 provides a general architecture and functionality suitable for implementing functional elements described herein or portions of functional elements described herein.

FIG. 8 is a flow chart illustrating another method according to example embodiments.

FIG. 9 is a flow chart illustrating another method according to example embodiments.

FIG. 10 illustrates a state machine diagram according to example embodiments.

FIG. 11 is a flow chart illustrating another method according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

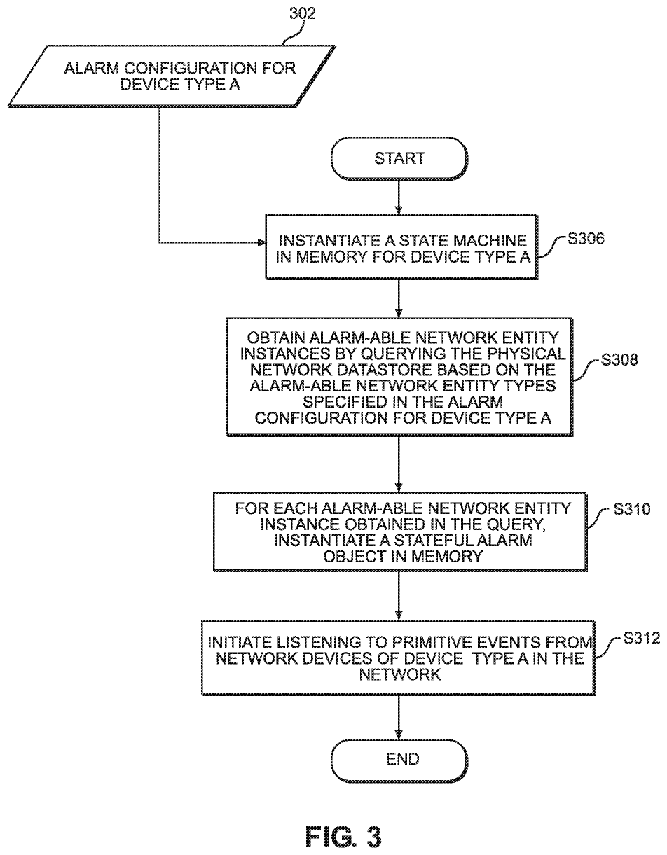

For example purposes, one or more methods described herein (e.g., in FIGS. 3, 4, 6, 8, 9 and/or) 11 will be discussed as being performed by an alarm virtual network function (VNF) or element thereof (e.g., an event routing and parsing sub-system) at a network management device in response to an event from, for example, a remote device. It should be understood, however, that the same or substantially the same method may be applicable to other network devices and other network device types.

Moreover, although discussed with regard to the alarm VNF (or element thereof) performing one or more of the operations of the methods discussed herein, it should be understood that the operations may also be described as being performed by the network management device or at least one processor in conjunction with at least one memory including computer program code at the network management device. In this regard, the at least one memory and the computer program code may be configured to, with the at least one processor, cause the network management device to perform the operations of the methods discussed herein.

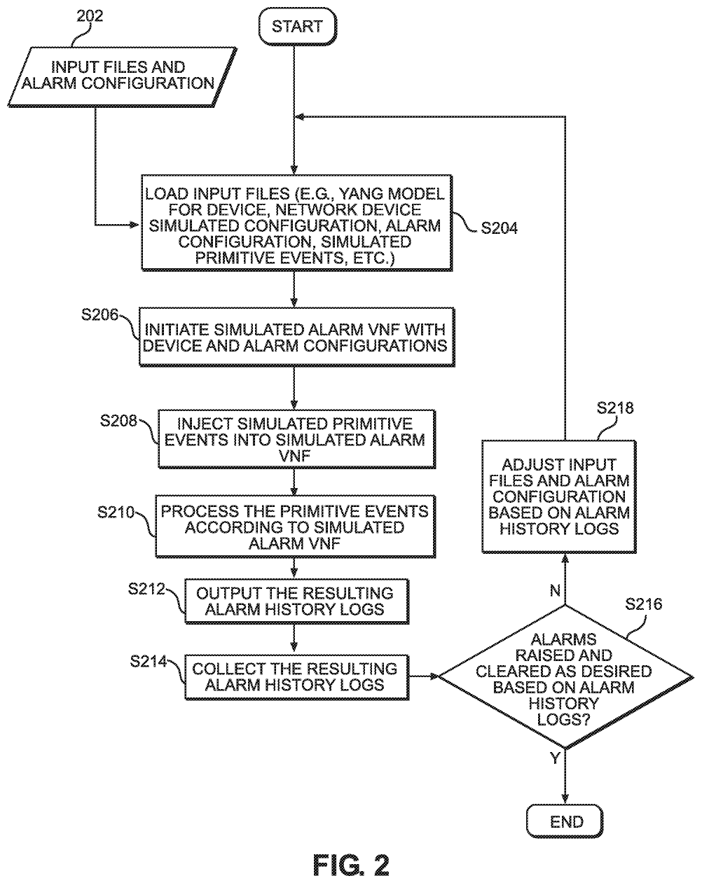

Similarly, the method shown in FIG. 2 may be discussed as being performed by an alarm simulation tool. It should be understood, however, that the same or substantially the same method may be applicable to other network devices and other network device types. Moreover, although discussed with regard to the simulation tool, it should be understood that the operations may also be described as being performed by at least one processor in conjunction with at least one memory including computer program code at the a device implementing the simulation tool. In this regard, the at least one memory and the computer program code may be configured to, with the at least one processor, cause a device or the simulation tool to perform the operations shown in FIG. 2.

Thresholds as discussed herein may be set by network operators based on empirical data, network conditions, or the like.

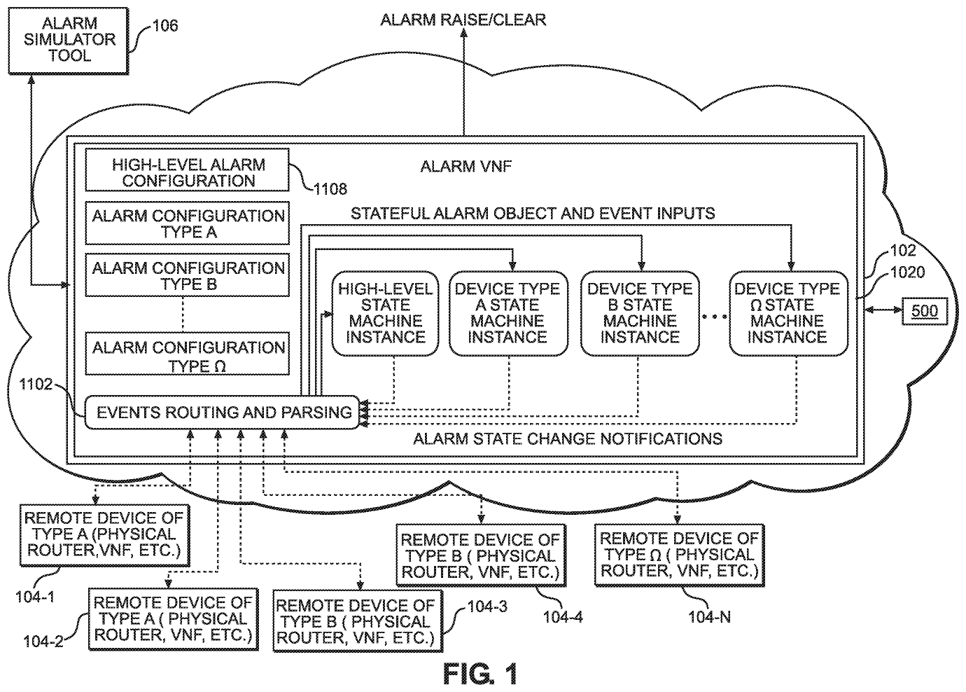

FIG. 1 is a simple network diagram illustrating a centralized device implementing an alarm VNF (also sometimes referred to as an alarm engine) according to example embodiments. In the example embodiment shown in FIG. 1, the centralized device will be discussed as a network management device (or entity). However, example embodiments should not be limited to this example.

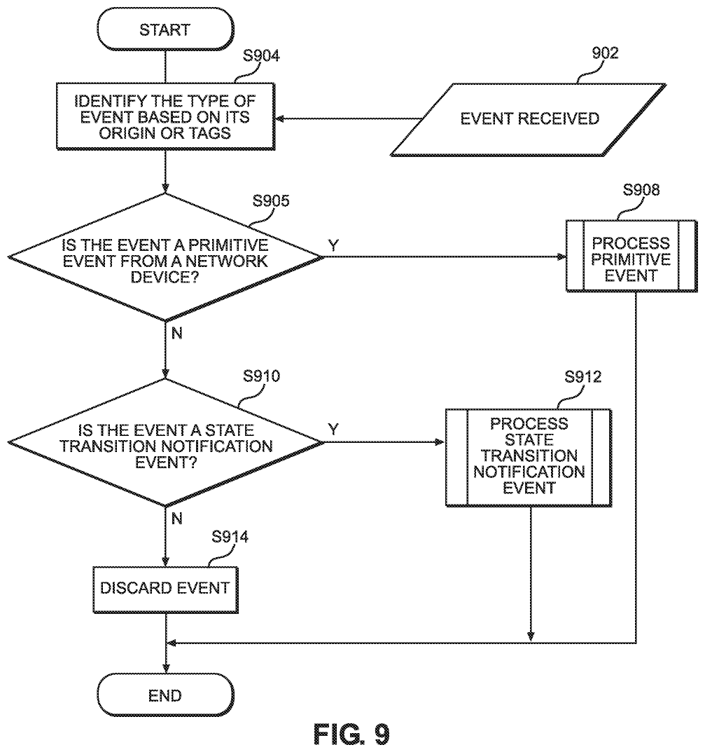

Referring to FIG. 1, the network management device 102 includes an alarm VNF 1020. The alarm VNF 1020 includes an events routing and parsing module or sub-system 1102, the function of which will be discussed in some detail later with regard to FIG. 9. The alarm VNF 1020 also includes a high-level alarm configuration 1108 and alarm configurations for a plurality of network device types.

In one example, the network management device 102 may be a network management server that is separate from the network devices, and that may connect and manage multiple networks or network devices remotely. Alternatively, the network management device 102 may be a distributed entity that is distributed among multiple different network management servers in a cloud architecture.

In the example embodiment shown in FIG. 1, the alarm VNF 1020 includes alarm configurations for network device types A through Ω (e.g., alarm configuration type A, alarm configuration type B, . . . , alarm configuration type Ω) for determining whether to generate (raise) or clear alarms in response to primitive events from one or more of remote network devices 104-1, 104-2, 104-3, 104-4, . . . , 104-N. According to at least some example embodiments, the remote network devices 104-1, 104-2, 104-3, 104-4, . . . , 104-N may be physical routers, VNFs, Internet Of Things (IOT) devices, or the like. The network management device 102 may store the alarm configurations in one or more memories.

The alarm VNF 1020 may include one or more virtual machines running different software and processes, and may be implemented on top of standard high-volume servers, switches and storage devices, or even a cloud computing infrastructure. In this regard, the alarm VNF 1020 may be implemented as software, hardware or a combination of software and hardware, as discussed in more detail later. A hardware computing platform for implementing the alarm VNF 1020 may be built around multiple server boards utilizing processing circuitry (e.g., one or more processors or processing cores).

The alarm VNF 1020 may be configured on a network device type-basis and may be centralized as a single function spanning multiple network devices (or network device instances). Rather than hosting its own alarm logic, a network device sends primitive events northbound to the alarm VNF 1020 as autonomous notifications (e.g., NETCONF notifications). The alarm VNF 1020 processes the primitive events based on the alarm configuration(s) for the network device type corresponding to the network device to determine whether to generate an alarm (e.g., in the northbound direction).

The alarm VNF 1020 may be configured at a higher level on a network-wide-basis, and as mentioned above, may be centralized as a single function spanning multiple network devices (or network device instances). The incremental high-level configuration may specify abstract or high-level stateful alarm objects. These stateful alarm objects may be instantiated directly based on the high-level alarm configuration, which includes link criteria that describe how other stateful alarm objects are related to a high-level stateful alarm object. Guard functions are configured to allow or block transitions based on state transition notification events. Thus, a high-level stateful alarm object may transition its state based on state transitions of other related stateful alarm objects, which are ultimately triggered, in turn, by primitive events from network devices. High-level alarms may be network-wide, rather than configured based a device yang model or on a device type basis.

An alarm configuration or stateful alarm object may be implemented based on state machine theory. For example, an alarm configuration may be implemented at least one of using hierarchical state machines, using state transition actions to trigger northbound alarm generation, using guard functions to enforce state transition criteria, or the like. As shown in FIG. 1, the alarm VNF 1020 may include a state machine instance implementing each of the alarm configurations.

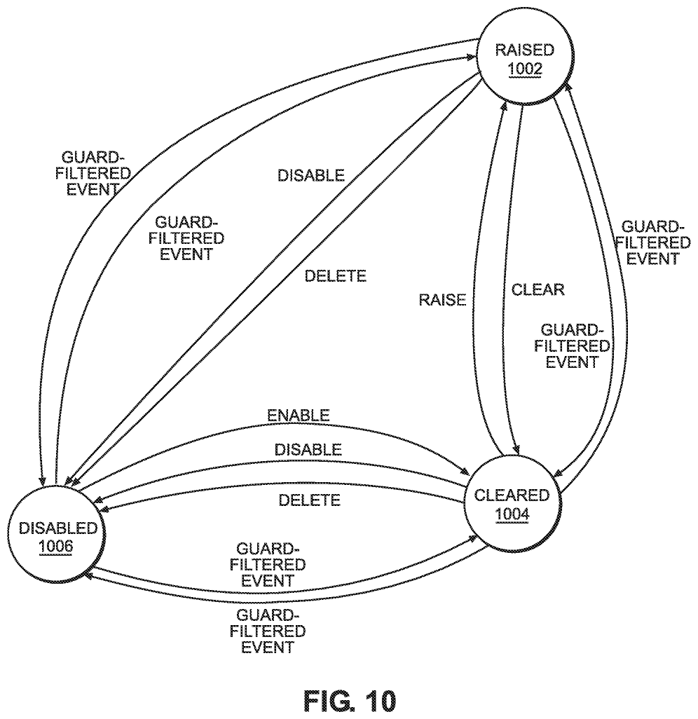

FIG. 10 illustrates a state machine diagram for implementing an alarm configuration, according to example embodiments.

Referring to FIG. 10, three different states may be used to qualify the behavior of stateful alarm objects: “disabled” represents a state where the stateful alarm object exists in memory but is not currently being used to dispatch Northbound Interface (NBI) alarm events, “cleared” represents a state where the stateful alarm object is not triggered, and “raised” represents a state where the stateful alarm object is triggered. Transitioning between any two states generates a state transition event, which may in turn be injected into the high-level alarm state machine. Transition actions may also include dispatching NBI alarm events. Transitions may be controlled by guard functions or filters, which are specified in the corresponding alarm type configuration.

An alarm configuration for a network device type may be in the form of an eXtensible Markup Language (XML) document (or file), and may be related to a corresponding yang model for the network device type. Alarm-able entity instances referred to in the alarm configuration (e.g., in the XML file) match yang model entities. In a NETCONF managed network, since NETCONF yang models are also XML-encoded, the yang model references fit naturally with the alarm configuration XML schema definition (XSD). The alarm configuration XSD specifies how to formally describe the elements in the alarm configuration XML file.

As mentioned above, an alarm configuration (also sometimes referred to as an alarm type configuration) may be an XML document including generated code (e.g., user generated, machine learning generated, etc.). In comparison, stateful alarm objects refer to run-time object instances in memory resulting from the alarm type configurations.

In the case of device type related alarm configurations (also sometimes referred to as device type alarm configurations), for each alarm type defined in an XML configuration, there can be many stateful alarm objects instantiated at run-time (e.g., for each corresponding network entity instance in each device instance of the device type). By contrast, in the case of high-level alarm configurations, for each high-level alarm type defined in the XML configuration, there may be only one stateful alarm object instantiated in memory at run-time.

In practice, high-level alarm type configurations may be changed on the fly, as desired to tweak high-level alarms. This may be relatively easily supported because each high-level alarm type configuration change may impact only a single stateful alarm object instance. This may have practical use given that network-wide requirements may change dynamically over time. By contrast, device type related alarm configurations generally remain unchanged because they are closely linked to the device type yang model. Alarm configurations and stateful alarm objects will be discussed in more detail below.

An example device type related alarm configuration for alarm type “violet” for network device type A is shown below.
Alarm type violet (external)
   /interfaces/interface
   Guard: match “critical hw problem started”
      Action raise alarm
   Guard: match “critical hw problem stopped”
      Action clear alarm.

In this example, the alarm configuration tags the alarm type violet as “external” or externally visible (as opposed to internal), and identifies the alarm-able network entity type (/interfaces/interface). The alarm configuration also includes two guard rules (Guard: match “critical hw problem started” and Guard: match “critical hw problem stopped”) and the corresponding action to be taken (state transition) if the respective guard rule results in TRUE.

At run time, a stateful alarm object contains the logic for the related alarm rule, which is invoked by the guard function in order to determine whether the state transition is allowed. The guard or guard function is a Boolean expression that follows the trigger of a state transition. The guard function returns TRUE or FALSE to determine whether the state transition should occur. If the guard function evaluates to TRUE, then the state transition is allowed, and the state transition occurs. If, however, the guard function evaluates to FALSE, then the state transition is not allowed. In this case, the state transition does not occur as a result of the primitive event because of the guard function.

Primitive events may include, for example, performance monitoring data (e.g., count), threshold crossings, operational state changes, configuration changes, or any autonomous notification.

In one example, a primitive event from a network device instance may identify the network entity instance associated with the primitive event (e.g., where the primitive event occurred). A network entity instance identification may be in the form of an XPath expression embedded as a parameter within the primitive event. An example format of a primitive event from remote network device instance 104-1 “remotedevice104-1” of type A is shown below.
Primitive event from network device instance “remotedevice104-1” of type A
   From network entity instance “/interfaces/interface[name=upif1]”
   Critical hw problem started

In this case, the network entity instance at which the primitive event occurred is interface network entity instance upif1 (“/interfaces/interface[name=upif1]”), and the primitive event is the start of a critical hardware problem “Critical hw problem started.”

In another example, a Threshold Crossing Alert (TCA) is a notification generated as a result of operational data values crossing a threshold (e.g., an inbound packets per second counter crossing an upper limit of about 100). A threshold crossing may be configured either at the network device layer or at the network management layer.

If a TCA is configured at the network device layer, then the resulting TCA is a primitive event sent by a network device to the alarm VNF 1020. In this case, the alarm VNF 1020 may be configured with rules specifying conditions or criteria (alarm configuration) for generating a northbound alarm in response to one or more TCA notifications from the network devices of a given type. In a case where only counter values are sent in primitive events from the network device to the alarm VNF 1020, a threshold may be configured directly in the alarm VNF 1020 such that the alarm VNF 1020 then performs the TCA function on behalf of the network device.

According to at least some example embodiments, a northbound notification may be one or more of a Kafka notification, a NETCONF notification, an alarm log sent to a repository for historical alarms, or any type of notification as required by a remote northbound client.

Still referring to FIG. 1, the alarm VNF 1020 may leverage a physical network datastore (e.g., an existing NETCONF datastore) at a network management database system 500.

Although FIG. 1 illustrates the network management database system 500 separate from the network management device 102, it should be understood that the network management database system may be located in a memory at the network management device 102 or separate from, but co-located with, the network management device 102.

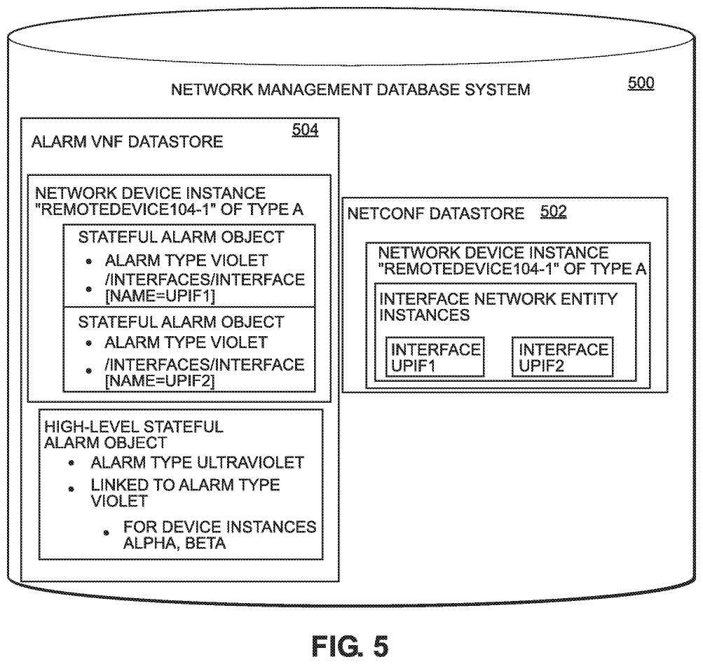

FIG. 5 is a block diagram illustrating a network management database system according to example embodiments.

Referring to FIG. 5, in this example, the network management database system 500 includes an alarm VNF datastore 504 and a NETCONF datastore 502.

The NETCONF datastore 502 is an example of a physical network datastore for a NETCONF-managed network. In this example, the NETCONF datastore 502 stores network configuration including network entity instances (resulting from NETCONF provisioning) for the physical network infrastructure. A NETCONF datastore may store network configuration information as encoded eXtensible Markup Language (XML) documents and files.

FIG. 5 illustrates two interface network entity instances upif1 and upif2 of network device instance “remotedevice104-1” of type A stored at the NETCONF datastore 502.

The alarm VNF datastore 504 includes stateful alarm objects for network entity instances stored in the NETCONF datastore 502. As mentioned above, a stateful alarm object (also referred to as a stateful alarm) is an object instantiated by the alarm VNF 1020 in memory to match an instance of an alarm-able network entity configured on a network device instance in the network. The stateful alarm object corresponding to a network device identifies an alarm type and network entity instance linking the stateful alarm object to the network entity instance within the network device instance. Each network entity instance may be linked to one or more stateful alarm objects. In one example, each of interface network entity instances upif1 and upif2 mentioned above may be linked to a stateful alarm instance of alarm type “violet” and/or a stateful alarm instance of alarm type “magenta” (not shown) for a total of four stateful alarm instances. As discussed in more detail later, the alarm VNF 1020 uses stateful alarm objects to match incoming primitive events to alarm-able instances and determine whether each primitive event should be injected into the state machine for further processing.

For example purposes, FIG. 5 shows only a stateful alarm object identifying interface network entity instance upif1 (“/interfaces/interface[name=upif1]”) and alarm type “violet,” and a stateful alarm object identifying interface network entity instance upif2 (“/interfaces/interface[name=upif2]”) and alarm type “violet.” However, example embodiments should not be limited to this example.

The alarm VNF datastore 504 further includes a high-level stateful alarm object with alarm type “ultraviolet.” This high-level stateful alarm object is configured independently of any device type, but is linked to the alarm type “violet” and device instances “alpha” and “beta.” The state transitions of the “ultraviolet” alarm instance are triggered by state transitions of “violet” stateful alarm objects linked to network entity instances within device instances “alpha” or “beta.”

Although discussed with regard to NETCONF and a NETCONF datastore, example embodiments may be applicable to a Simple Network Management Protocol (SNMP) network and an equivalent datastore for SNMP network devices, which is referred to as a Management Information Base (MIB).

Returning to FIG. 1, an alarm simulator tool (also referred to herein as a simulation tool or alarm simulation tool) 106 may be used to generate and adjust alarm configurations for network device types (e.g., physical routers, VNFs, IOT device types, etc.) within the network.

The simulation tool 106 may be a standalone tool implemented on a hardware computing platform at, for example, a remote network location. Similar to the alarm VNF 1020, the hardware computing platform may be built around multiple server boards utilizing processing circuitry (e.g., one or more processors or processing cores).

The simulation tool 106 may simulate the alarm logic associated with a given alarm configuration to enable alarm behavior to be configured offline without having to setup an entire network management software stack. In this way, an alarm configuration may be realized and adjusted more easily and via quicker iterations, and then uploaded and implemented at the alarm VNF 1020 at the network management device 102. Example operation of the simulation tool 106 will be discussed in more detail later with regard to FIG. 2.

FIG. 3 is a flow chart illustrating a method for configuring an alarm VNF with device alarm type configurations, according to example embodiments.

The alarm VNF 1020 may be configured based on, or according to, alarm configurations input to the alarm VNF 1020. The alarm configurations may be generated and/or adjusted as discussed later with regard to FIG. 2, or in any other suitable manner.

Referring to FIG. 3, at step S306, in response to receiving (input of) an alarm configuration for network device type A (302), the alarm VNF 1020 instantiates a state machine for network device type A in the memory at the network management device 102. The alarm VNF 1020 may instantiate a state machine for network device type A in any well-known manner.

At step S308, the alarm VNF 1020 obtains alarm-able network entity instances configured in the network from the NETCONF datastore 502 based on the alarm-able network entity types specified in the alarm configuration for network device type A. According to one or more example embodiments, the alarm VNF 1020 may obtain the alarm-able network entity instances by querying the NETCONF datastore 502 based on the alarm-able network entity types.

Referring back to the example alarm configuration for alarm type “violet,” in this example, the alarm VNF 1020 may identify interface network entity instances upif1 and upif2 as alarm-able based on the network entity type included in the alarm configuration.

At step S310, the alarm VNF 1020 instantiates one or more stateful alarm objects in the memory (to create a stateful alarm object instance) for each alarm-able network entity instance obtained at step S308. In one example, the alarm VNF 1020 may instantiate the stateful alarm object(s) in the alarm VNF datastore 504. In the example discussed with regard to step S308, the alarm VNF 1020 may instantiate the stateful alarm objects shown in FIG. 5.

At step S312, the alarm VNF 1020 begins listening to primitive events from network devices in the network. According to at least some example embodiments, when a network device is configured, the type of the network device is stored as a parameter as part of the network device instance configuration within the NETCONF datastore 502. The alarm VNF 1020 may identify a network device instance as a given type (e.g., type A) based on these parameters.

Once device alarm types are configured, the alarm VNF 1020 identifies and processes events based on the device alarm configurations.

FIG. 9 is a flow chart illustrating a method for identifying and processing events arising and/or received at the alarm VNF.

Referring to FIG. 9, at step S904, the alarm VNF 1020 identifies the type of event to be processed based on the origin or tags attached to or within the received event (902 in FIG. 9).

Once having identified the type of event to be processed, if the alarm VNF 1020 determines that the event type is not a primitive event from a network device (step S905) or a state transition notification event (step S910), then the alarm VNF 1020 discards the event at step S914.

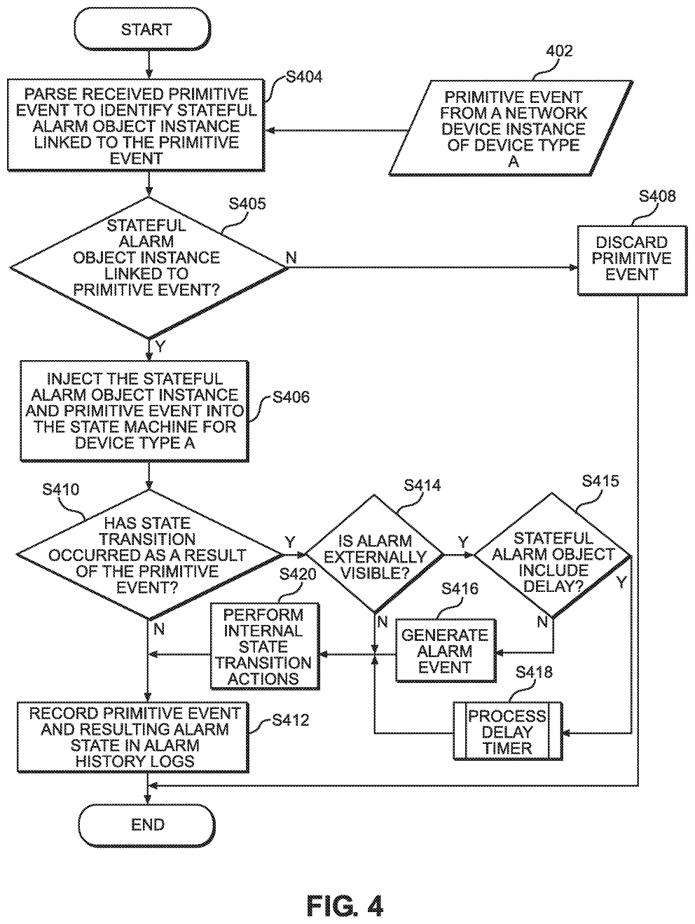

Returning to step S905, if the alarm VNF 1020 identifies the event type as a primitive event received from a network device, then the alarm VNF 1020 processes the primitive event at step S908 to determine whether to generate an alarm. An example embodiment of a method for processing of a primitive event at step S908 will be discussed in more detail below with regard to FIG. 4.

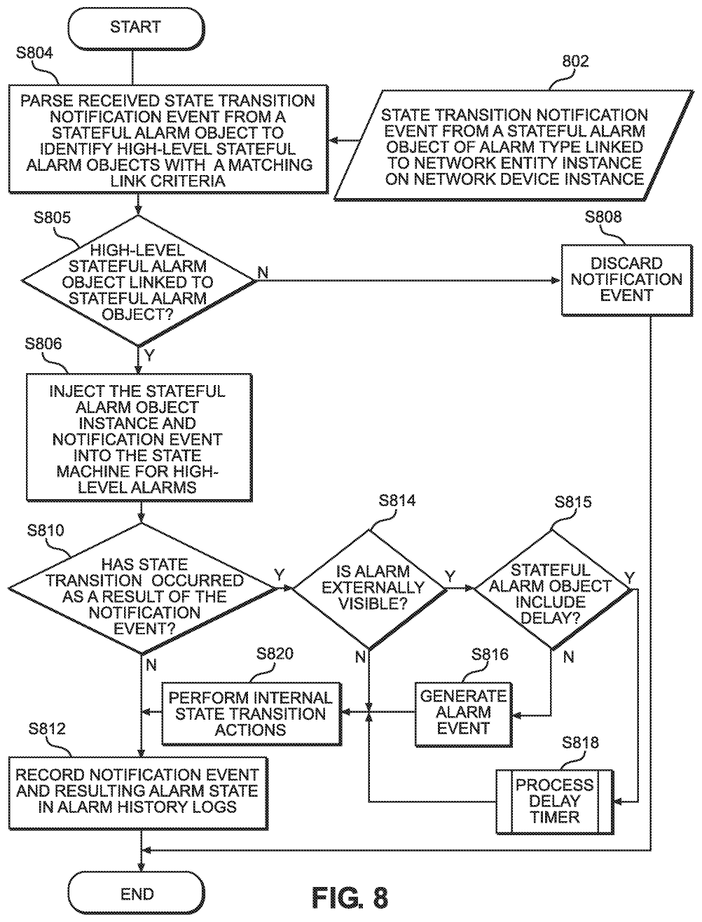

Returning to step S910, if the alarm VNF 1020 identifies the event type as a state transition notification event, then the alarm VNF 1020 processes the state transition notification event at step S912 to determine whether to generate an alarm. An example embodiment of a method for processing a state transition notification event at step S912 will be discussed in more detail below with regard to FIG. 8.

FIG. 4 is a flow chart illustrating a method of processing a primitive event according to example embodiments. For example purposes, the method shown in FIG. 4 will be discussed with regard to a primitive event from remote device 104-1 as network device type A.

Referring to FIG. 4, at step S404, the alarm VNF 1020 parses the primitive event received from the remote network device 104-1 (402 in FIG. 4) in an effort to identify a stateful alarm object instance linked to the primitive event. In one example, the alarm VNF 1020 may identify the stateful alarm object instance by examining the XPath expression included in the primitive event to identify the network entity instance referenced in the primitive event and then attempting to match the identified network entity instance to a network entity instance included in a stateful alarm object in the alarm VNF datastore 504.

If the alarm VNF 1020 is unable to identify a stateful alarm object linked to the primitive event (e.g., the network entity instance included in the primitive event does not match a network entity instance in the alarm VNF datastore 504) at step S405, then at step S408 the alarm VNF 1020 discards the primitive event and the process terminates for the received primitive event.

Returning to step S405, if the alarm VNF 1020 is able to identify a stateful alarm object linked to the primitive event (e.g., the network entity instance included in the primitive event matches a network entity instance in the alarm VNF datastore 504), then at step S406 the alarm VNF 1020 inputs or injects the primitive event and the stateful alarm object instance linked to the primitive event into the state machine for network device type A.

At step S410, the alarm VNF 1020 determines whether the primitive event causes a state transition in the state machine for the network device type A. as discussed above with regard to FIG. 10, in at least one example, the state machine may be in one of three states: disabled, cleared and raised. In this example, the state transition may be from cleared to raised, raised to cleared, etc. Disabled may be used to represent alarms that cannot be raised based on current network conditions or configurations.

If the alarm VNF 1020 determines that a state transition has not occurred in response to the primitive event at step S410, then at step S412 the alarm VNF 1020 records at least the primitive event and resulting alarm state in the alarm history logs. Also at step S412, the alarm VNF 1020 may discard the primitive event. The process then terminates with respect to the stateful alarm object and primitive event, and the next stateful alarm object and/or primitive event is processed (if necessary or desired).

According to at least some example embodiments, alarm history logs may include chronological lists of one or more of received primitive events, other events arising at the alarm VNF, events injected into the alarm VNF state machine, resulting state transitions, related actions or northbound alarms raised or cleared. Accordingly, alarm history logs may be characterized as capturing the alarm VNF logic and related behavior. The alarm history logs may be stored in a memory at the network management device 102. In one example, the alarm history logs may be circular logs used in order to save memory resources given that there could potentially be millions of stateful alarm objects and each could have thousands of logs.

According to one or more example embodiments, primitive events may be processed asynchronously, but in the order received. As a result, the southbound interface thread notifying the alarm VNF 1020 of a primitive event need not wait for the state machine to process the primitive event. Rather, the primitive event may be transferred into a queue to be processed in the order received by another thread running in the background. As an alternative, the primitive events may be processed synchronously in that the same thread is used to notify the alarm VNF 1020, go through the state machine and execute the transition and repeat for each primitive event.

Returning to step S410 in FIG. 4, if the alarm VNF 1020 determines that a state transition has occurred in response to the primitive event, then at step S414 the alarm VNF 1020 determines whether the alarm is externally visible. Whether an alarm is externally visible may be driven by a property of the alarm definition in the alarm configuration for the network device type A. As discussed above, for example, a property of the alarm definition may tag the alarm as external.

An externally visible alarm is an alarm that triggers an external alarm event. This is in contrast to an internal (or silent) alarm, which does not trigger an external alarm event, even though the state transition (e.g., to a “raised” state) may occur as a result of a primitive event from a network device. Thus, in one example, an internal alarm can be in the “raised” state without notifying any Alarm VNF Northbound Interface (NBI) clients that are listening to alarms. This may be useful in scenarios where an internal alarm is used in the guard of another alarm definition to allow/block a transition for the other alarm. Internal alarms allow for aggregation, combination and/or sequencing of primitive events leading to an external alarm event at the alarm VNF NBI clients.

External alarms may also depend on each other with regard to aggregation and/or correlation.

In one example, an internal alarm may be useful where stateful alarm objects are linked to other stateful alarm objects and a combination of internal objects is used as a condition to help trigger the external alarm tied to yet another external stateful alarm object. The alarm VNF 1020 may track the combination or sequence of alarms using internal stateful alarm objects, while an additional external stateful alarm object can be used to trigger the external alarm.

In one example, alarm aggregation may aggregate multiple narrow-scoped alarms into a single wider-scoped alarm event. For example, if all ports on a network card lose a signal, multiple primitive events may be issued by the network device, but the alarm VNF 1020 may generate only a single card-level alarm event instead of 24 port-level alarm events. Similarly, wider-scoped alarms across multiple network device instances, or groups thereof, may be used to aggregate more specific alarms in each network device instance.

As mentioned above, an alarm event may be a result of alarm correlation in which an alarm is raised as a result of a combination of multiple alarms. Alarm correlations may be based on the yang model hierarchy or yang reference heuristics associated with the alarm configuration. For example, the yang model may contain a flat list of interfaces (not hierarchical), and some interfaces may be linked to others using references at run-time. Some interfaces may be configured as aggregations of other interfaces or are configured as protection pairs, or the like, at run-time. These various link flavors may be defined in the yang model. In this example, the alarm correlation logic may operate based on these links flavors.

In at least one example, external alarms may be hierarchical in that a single parent alarm is raised instead of one alarm for each child. In this case, the external alarm guard may include a condition to be raised if all children alarms are raised. The children alarms may be cleared as a result of the parent alarm being raised, and the parent alarm may eventually be cleared based on the resolution of some or all child conditions.

Returning to FIG. 4, if the alarm VNF 1020 determines that the alarm is not externally visible at step S414, then the alarm VNF 1020 executes any necessary and/or appropriate internal alarm state transition actions. The alarm state transition actions are configurable via the alarm device configuration within the alarm VNF 1020. In one example, the internal alarm state transition actions may include generating an alarm state change notification event. An alarm state change notification event is discussed in more detail with regard to FIGS. 8 and 9.

After executing the one or more alarm state transition actions at step S420, the process proceeds to step S412 and continues as discussed above.

Returning to step S414, if the alarm VNF 1020 determines that the alarm is externally visible, then at step S415 the alarm VNF 1020 determines whether the stateful alarm object contains an associated delay.

According to at least some example embodiments, alarms may be timed (e.g., using a counter) such that the alarms are only exposed after a timeout (e.g., expiration of a threshold time interval) and if the condition is not reverted prior to the timeout. A stateful alarm object may have (or include) a hysteresis timer configured with regard to a state transition. In case of transition into a given state, the alarm may be delayed based on the timer setting. If the stateful alarm is transitioned out of the state before the timer expires, then the timer is removed and the external alarm is not dispatched northbound. This enables the alarm VNF 1020 to send alarms only if a network condition persists for a threshold (e.g., minimum threshold) amount time. In contrast, without a timer, intermittent and frequent network conditions may cause certain alarms to toggle between raise and cleared at a relatively high frequency and cause unnecessary noise, distraction and/or resource diversion at the northbound client. The alarm state machine may simply keep transitioning immediately as reciprocal primitive events are received indicating the presence or absence of a network condition. The timeout length (or length of the threshold time interval) may be set by a network operator based on empirical data, network conditions, or the like.

Hysteresis alarm delay applications are not limited to toggling, and may be timed according to the application at hand. According to one or more example embodiments, a period of about 60 minutes may be used as the threshold time interval to manage toggling alarms. However, the delay may be used for applications other than toggling also, such as tracking network deployment artifacts. For example, an Optical Network Termination (ONT) device at a customer premises may be deployed, but not completely configured at the time of deployment. A delayed alarm type may be used to indicate that the new ONT device is still not yet configured completely, for example, 15 minutes after initial deployment. If the configuration is completed within 15 minutes, then the delayed alarm may be cleared without dispatching a raise notification to the NBI client. So, the NBI client is notified only if there is an issue with regard to a new ONT configuration.

Still referring to FIG. 4, if the alarm VNF 1020 determines that the stateful alarm object does not include an associated delay timer, then at step S416 the alarm VNF 1020 generates an alarm event (e.g., indicating raised, cleared, disabled, etc.).

In at least one example embodiment, the alarm VNF 1020 may generate an alarm event by autonomously producing a message which is ultimately received by alarm VNF clients listening for alarms from the network. Examples of VNF clients are an operations support system (OSS), a business support system (BSS) providing network-wide monitoring, etc. An alarm event may be in the form of a NETCONF notification or Kafka message, or any other suitable messaging format used for network monitoring.

With regard to an OSS, for manual monitoring by a network operator at the OSS, an alarm event may result in a Graphical User Interface (GUI) entry in the OSS software application, which may trigger action (e.g., correction of a fault in the network, such as rerouting traffic) by the network operator. For automated networks, an alarm event may result in a closed loop automation action so as to automatically correct a problem or fault in the network, if possible. Alarm events may be caused by, for example, fiber cuts, laser failures in Passive Optical Networks (PONs), laser overheating, packet congestion, packet loss, or the like.

After generating the alarm event at step S416, the process proceeds to step S420 and continues as discussed above.

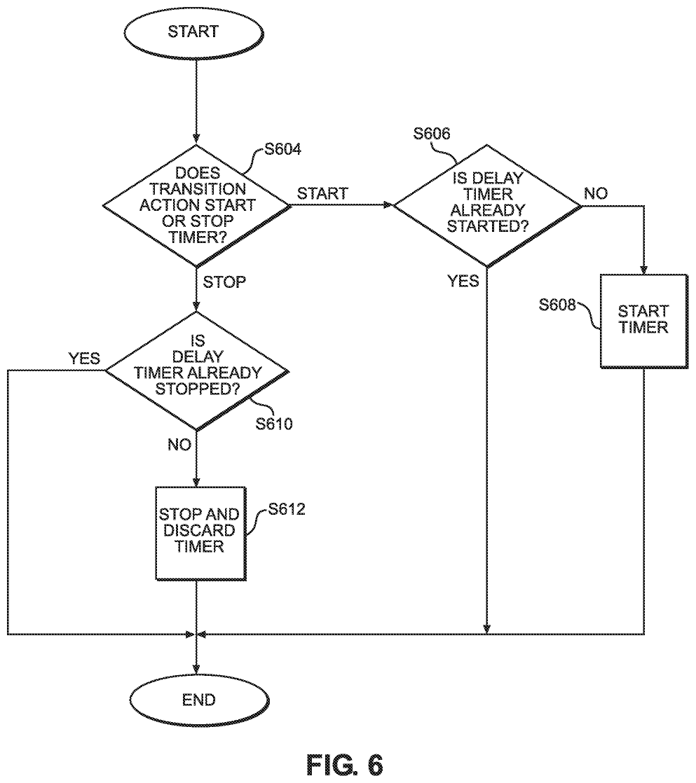

Returning to step S415, if the stateful alarm object does include an associated delay timer, then the alarm VNF 1020 processes the delay timer at step S418. The process then proceeds to step S420 and continues as discussed above. An example embodiment of a method for processing of the delay timer at step S418 will be discussed in more detail below with regard to FIG. 6.

Although not specifically shown in FIG. 4, the alarm VNF 1020 may perform a continuous background flow to check for expired timer entries from a list of (e.g., software) timer entries associated with stateful alarm objects. If a timer entry expires before the timer is stopped (e.g., as a result of a transition to another state), then the expiration of the timer entry triggers the alarm VNF 1020 to generate an alarm.

FIG. 6 is a flow chart illustrating a method for processing a delay timer at step S418 according to example embodiments.

Referring to FIG. 6, at step S604 the alarm VNF 1020 determines whether the state transition results in (triggers) start or stop of the delay timer associated with the stateful alarm object. In at least one example embodiment, the alarm VNF 1020 determines whether the state transition triggers start or stop of the delay timer by examining the alarm configuration.

The delay timer may be configured in the alarm configuration for a given alarm type, and the configuration may be passed to the stateful alarm object when the stateful alarm object is instantiated.

The delay timer may be configured to start when transitioning to the “raised” state, and to stop when transitioning out of the “raised state.” The reciprocal behavior may also be associated with the “cleared” state, for a clear alarm event. An alarm configuration for an alarm type may specify the multiple timers (e.g., one for the “raised” state, another for the “cleared” state, etc.)

If the alarm VNF 1020 determines that the state transition is a trigger for starting the delay timer, then at step S606 the alarm VNF 1020 determines whether the delay timer is already started. In one example, a boolean (e.g., T or F) for each delay timer in the stateful alarm object may be used to indicate whether a timer is started or stopped. In another example, the alarm VNF 1020 may check the list of timers running in the background. If the delay timer is in the list, then the delay timer is currently running.

If the alarm VNF 1020 determines that the delay timer has not been started, then at step S608 the alarm VNF 1020 starts the delay timer. The alarm VNF 1020 then adds the delay timer to the list of delay timers to monitor for expiration in the background.

Returning to step S606, if the alarm VNF 1020 determines that the delay timer has already been started, then the alarm VNF 1020 need not start the delay timer, and the process terminates.

Returning now to step S604, if the state transition results in (triggers) stop of the delay timer associated with the stateful alarm object, then at step S610 the alarm VNF 1020 determines whether the delay timer is already stopped. As mentioned above in one example, a boolean (e.g., T or F) for each delay timer in the stateful alarm object may be used to indicate whether a timer is started or stopped. In another example, the alarm VNF 1020 may check the list of timers running in the background. If the delay timer is not in the list, then the delay timer is stopped.

If the alarm VNF 1020 determines that the delay timer is not already stopped, then at step S612 the alarm VNF 1020 stops and discards the delay timer by removing the delay timer from the list of timers being monitored for expiration in the background. The process then terminates.

Returning to step S610, if the alarm VNF 1020 determines that the delay timer is already stopped, then the alarm VNF 1020 need not stop and discard the delay timer and the process terminates.

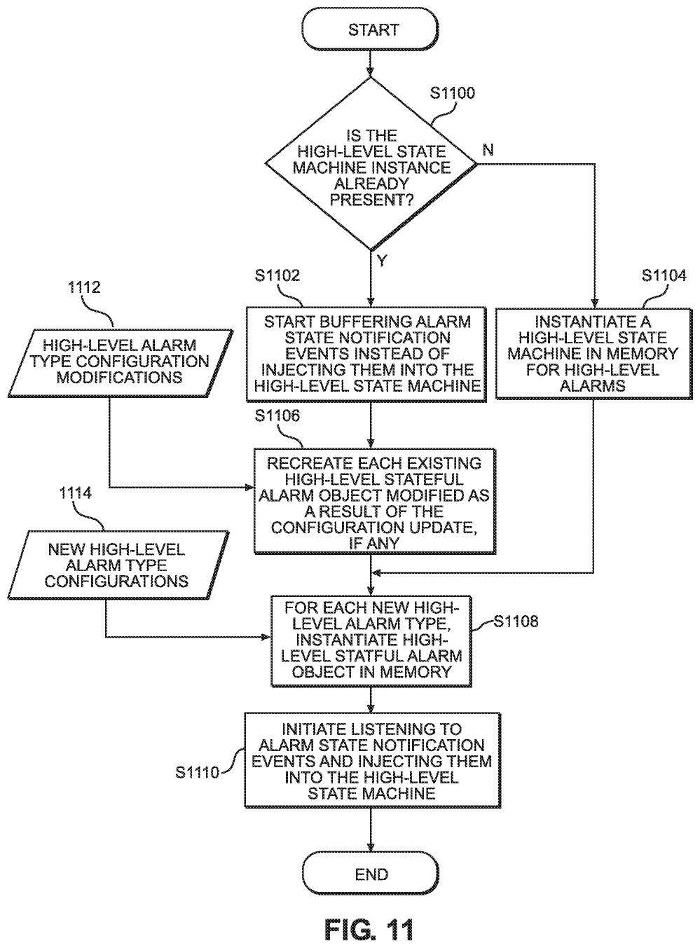

FIG. 11 is a flow chart illustrating a method for configuring an alarm VNF with high-level alarm configurations (e.g., the high-level alarm configuration 1108 in FIG. 1), according to example embodiments.

Referring to FIG. 11, at step S1100, the alarm VNF 1020 determines whether a high-level state machine instance has already been instantiated.

If the high-level state machine has already been instantiated, then at step S1102 the alarm VNF 1020 temporarily stops processing incoming alarm state notifications and starts buffering them instead. This enables the alarm VNF 1020 to make changes to the existing high-level alarms state machine on-the-fly.

At step S1106, the alarm VNF 1020 receives any high-level alarm type configuration changes (e.g., generated using the simulation tool and input/uploaded by a user) (1112 in FIG. 11), and recreates each corresponding stateful alarm object based on the received high-level alarm type configuration changes. It is noted that step S1106 may be omitted if no high-level alarm configuration changes are present.

At step S1108, the alarm VNF 1020 receives any new high-level alarm type configurations (1114 in FIG. 11), and the alarm VNF 1020 creates a single high-level stateful alarm object in memory for each new high-level alarm type configuration.

Once high-level alarms are configured, the alarm VNF 1020 begins listening to alarm state events and injecting the alarm state events into the high-level state machine at step S1110.

Returning to step S1100, if the high-level state machine instance has not already been instantiated, then at step S1104, the alarm VNF 1020 instantiates a state machine for high-level alarms in the memory at the network management device 102. The alarm VNF 1020 may instantiate a state machine for high-level alarms in the same or substantially the same manner as discussed above with regard to step S306 in FIG. 3. The process then proceeds to step S1108 and continues as discussed above.

FIG. 8 is a flow chart illustrating a method of processing a state transition notification event (e.g., at step S912 in FIG. 9) according to example embodiments.

Referring to FIG. 8, at step S804, the alarm VNF 1020 parses the alarm state transition notification event (802 in FIG. 8) resulting from the prior state transitions of stateful alarm objects to identify high-level stateful alarm objects with matching link criteria in the alarm VNF datastore 504. In one example, the alarm VNF 1020 may identify the related or linked high-level stateful alarm object instances by examining the sender alarm stateful object details included in a notification event.

If the alarm VNF 1020 is unable to identify a high-level stateful alarm object linked to the alarm state transition notification event at step S805, then at step S808 the alarm VNF 1020 discards the alarm state transition notification event and the process terminates for the current alarm state transition notification event.

Returning to step S805, if the alarm VNF 1020 is able to identify a stateful alarm object linked to the alarm state transition notification event, then at step S806 the alarm VNF 1020 inputs or injects the alarm state transition notification event and the stateful high-level alarm object instance linked to the alarm state transition notification event into the high-level state machine at the alarm VNF 1020.

At step S810, the alarm VNF 1020 determines whether the alarm state transition notification event causes a state transition in the high-level state machine. As discussed above with regard to FIG. 10, the state machine may be in one of three states: disabled 1006, cleared 1004 and raised 1002. In this example, the state transition may be from cleared 1004 to raised 1002, raised 1002 to cleared 1004, etc. Disabled 1006 may be used to represent alarms that cannot be raised based on current network conditions or configurations.

If the alarm VNF 1020 determines that a state transition has not occurred in response to the alarm state transition notification event at step S810, then at step S812 the alarm VNF 1020 records at least the alarm state transition notification event and resulting alarm state in the alarm history logs. Also at step 5812, the alarm VNF 1020 may discard the alarm state transition notification event. The process then terminates with respect to the stateful alarm object and alarm state transition notification event, and the next stateful alarm object and/or alarm state transition notification event or primitive event may be processed (if necessary or desired).

As with primitive events, alarm state transition notification events may be processed asynchronously, but in the order they arise. The alarm state transition notification event may be transferred into a queue to be processed in the order received by another thread running in the background. As an alternative, the alarm state transition notification events may be processed synchronously in that the same thread is used to notify the alarm VNF 1020, go through the state machine and execute the transition and repeat for each alarm state transition notification event.

Returning to step S810 in FIG. 8, if the alarm VNF 1020 determines that a state transition has occurred in response to the alarm state transition notification event, then at step S814 the alarm VNF 1020 determines whether the alarm is externally visible. As discussed earlier, whether an alarm is externally visible may be driven by a property of the alarm definition in the alarm configuration.

If the alarm VNF 1020 determines that the alarm is not externally visible at step S814, then at step S820 the alarm VNF 1020 executes any necessary and/or appropriate internal alarm state transition actions in the same or substantially the same manner as discussed above with regard to step S420 in FIG. 4, except that the alarm state transition actions are configurable via the high-level alarm configuration at the alarm VNF 1020, and a typical action is to generate an alarm state change notification event.

After executing the one or more alarm state transition actions at step S820, the process proceeds to step S812 and continues as discussed above.

Returning to step S814, if the alarm VNF 1020 determines that the alarm is externally visible, then at step S815 the alarm VNF 1020 determines whether the stateful alarm object contains an associated delay. The alarm VNF 1020 may determine whether the stateful alarm object includes an associated delay in the same or substantially the same manner as discussed above with regard to step S415 in FIG. 4.

If the alarm VNF 1020 determines that the stateful alarm object does not include an associated delay timer, then at step S816 the alarm VNF 1020 generates an alarm event.

After generating the alarm event at step S816, the process proceeds to step S820 and continues as discussed above.

Returning to step S815, if the stateful alarm object does include an associated delay timer, then the alarm VNF 1020 processes the delay timer at step S818. The process then proceeds to step S820 and continues as discussed above. The VNF 1020 may process the delay timer at step S818 in the same or substantially the same manner as discussed above with regard to step S418 in FIG. 4 and FIG. 6.

As with FIG. 4, although not specifically shown in FIG. 8, the alarm VNF 1020 may perform a continuous background flow to check for expired timer entries from a list of timer entries associated with stateful alarm objects. If a timer entry expires before the timer is stopped (e.g., as a result of a transition to another state), then the expiration of the timer entry triggers the alarm VNF 1020 to generate an alarm.

FIG. 2 is a flow chart illustrating a method for generating and adjusting an alarm configuration for a network device type using a simulation tool according to example embodiments.

According to at least this example embodiment, input files and initial alarm configuration(s) (202) to be utilized by the simulation tool 106 may be generated and input prior to the simulation by the simulation tool 106. The input files and initial alarm configuration(s) may be generated by a user, using artificial intelligence, machine learning algorithms, a combination thereof, or the like. The input files may include a yang model for a network device to be simulated, a configuration of a network device to be simulated and simulated primitive events to test the alarm configuration for the network device type. The input files may be formatted in the manner discussed above to simulate actual network yang models, network device configurations, primitive events, etc. The alarm configuration may also be formatted in the same or substantially the same manner as discussed above.

For the purposes of describing FIG. 2, the alarm VNF will be referred to as the “simulated alarm VNF”.

Referring to FIG. 2, at step S204, the simulation tool 106 loads the input files and the initial alarm configuration to be tested.

At step S206, the simulation tool 106 initiates the simulated alarm VNF with the loaded network device and alarm configuration. In more detail, according to at least some example embodiments, at step S206 the simulation tool 106 may load the simulated device type yang model into a schema registry in memory, and then load and validate the simulated device configuration using the schema registry (e.g., a configuration with a typographical error will not match the device yang model and may be flagged as invalid by the schema registry). Also at step S206, the simulation tool 106 may load and validate the alarm configuration for the simulated device type using the schema registry (e.g., similarly to the simulated device configuration validation with regard to the yang model).

The simulation tool 106 may then instantiate, in a memory, the state machine and stateful alarm objects corresponding to all alarm-able network entity instances found in the simulated device configuration and corresponding to the alarm VNF configurated rule. In one example, a first simulated interface network entity instance upif1_sim of type “LaInterface” may be specified in the simulated device configuration, and an alarm VNF configurated rule ruleZ corresponding to any simulated interface network entity instance of type LaInterface may be specified to match. This results in the stateful alarm object “ruleZforInterfaceupif1_sim” to be instantiated in the memory. Any subsequent primitive event from the simulated network device corresponding to simulated interface network entity instance upif1_sim may be matched to ruleZforInterfaceupif1_sim in the simulated alarm VNF. As a result of the match, the event is injected into the alarm VNF state machine where guard function rules linked to ruleZforInterfaceupif1_sim are invoked to determine whether a transition occurs, which, in turn, triggers a state transition action that may result in the generation of the alarm at the northbound interface of the simulated alarm VNF. The guard function rules may be the same or substantially the same as those discussed above.

At step S208, the simulation tool 106 injects the simulated primitive event or events into the simulated alarm VNF. In at least one example embodiment, the simulated alarm VNF listens to simulated NETCONF notifications from any simulated device at the southbound interface. If a primitive event is linked to a network entity instance that matches a stateful alarm object (e.g., ruleZforInterfaceupif1_sim discussed above), then the simulated alarm VNF injects (or inputs) the primitive event into the state machine. If the primitive event is not linked to a network entity instance that matches a stateful alarm object, then the simulated alarm VNF may discard the simulated primitive event.

At step S210, the simulation tool 106 processes the simulated primitive event or events linked to a network entity instance matching a stateful alarm object, and at step S212 the simulation tool 106 outputs the resulting alarm history logs. The alarm history logs may be the same or substantially the same as those discussed above with regard to FIGS. 4 and 8, for example.

At step S214, the resulting alarm history logs are collected, and at step S216 a determination is made regarding whether the raising and clearing of alarms in the alarm history logs is correct. The collecting and determining at steps S214 and S216, respectively, may be performed using artificial intelligence or machine learning algorithms implemented by the simulation tool 106. Alternatively, the collecting and determining at steps S214 and S216, respectively, may involve human operator intervention. According to at least some example embodiments, in the context of supervised machine learning, a learning algorithm may be pre-trained based on arbitrary examples, and then used to test the alarm VNF configuration based on the training. Conversely, the alarm VNF (simulated or actual) itself may be implemented using a supervised machine learning algorithm instead of a state machine. In this example, the algorithm may be trained to produce an inferred function that maps an input vector (e.g., primitive event parameters) to a desired output value (e.g., raise or clear alarm).

If it is determined that the raising and clearing of alarms in the alarm history logs is correct (or as desired) at step S216, then the simulation is complete. The alarm configuration may then be uploaded to, for example, the alarm VNF 1020 at the network management device 102.

Returning to step S216, if it is determined that the raising and clearing of alarms in the alarm history logs is not correct (not as desired), then the input files and/or alarm configuration may be adjusted accordingly at step S218. The adjusting at step S218 may be performed using artificial intelligence, machine learning algorithms, or via human operator intervention. With regard to the example noted above, the input files and/or alarm configuration may need to be adjusted if the admin state of the interface network entity instance transitions from up to down and a primitive event is sent to the simulated alarm VNF leading to an alarm being generated by the simulated alarm VNF as a result as specified in ruleZforInterfaceupif1_sim, but it is arbitrarily decided that the alarm be only raised if interface network entity instance is configured with the traffic profile P for interface of type LaInterface. In this case, the rule ruleZ configuration may be adjusted to take into account the traffic profile P over and above the admin state.

The simulation tool according to one or more example embodiments provides the ability to generate and test alarm configurations off-line before being uploaded to the network management device for use in the network.

According to one or more example embodiments, an alarm VNF may be configured more dynamically and on-the-fly by defining alarm configurations for different device types, and then inputting the defined alarm configurations into the network management device to configure the alarm VNF for a particular network device type or types.

Although discussed with regard to a state machine having three states (disabled, cleared, raised), as per FIG. 10, example embodiments may utilize more complex state machines involving any number of states. For example, a state machine involving minor-raised, major-raised, critical-raised states instead of a single raised state, or adding a sub-states such as service-affecting, performance-affecting, alarm-able entity configuration A, B, C or D, etc.

Moreover, although example embodiments are discussed herein with regard to a state machine, example embodiments should not be limited to this example. Rather, machine learning algorithms may also be used.

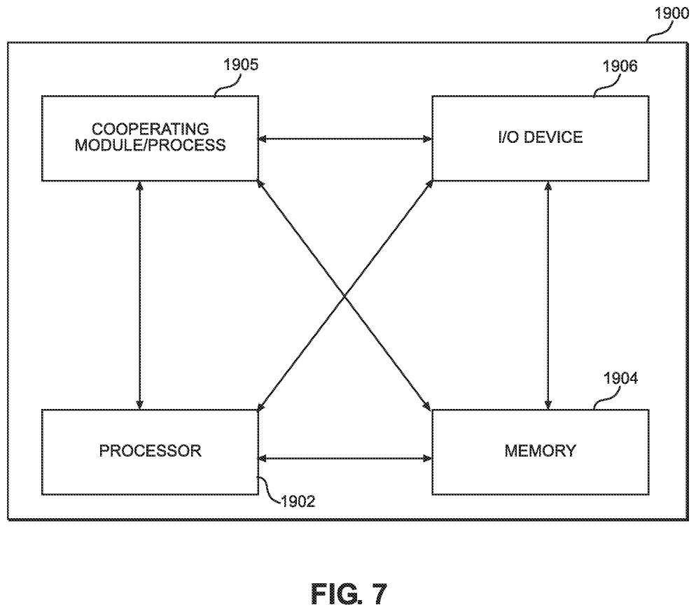

FIG. 7 depicts a high-level block diagram of a computer, computing or electronic device suitable for use in implementing, inter alia, network management devices, as well as other network elements and/or devices.

Referring to FIG. 7, the computer 1900 includes one or more processors 1902 (e.g., a central processing unit (CPU) or other suitable processor(s)) and a memory 1904 (e.g., random access memory (RAM), read only memory (ROM), and the like). The computer 1900 also may include a cooperating module/process 1905. The cooperating process 1905 may be loaded into memory 1904 and executed by the processor 1902 to implement functions as discussed herein and, thus, cooperating process 1905 (including associated data structures) may be stored on a computer readable storage medium (e.g., RAM memory, magnetic or optical drive or diskette, or the like).

The computer 1900 also may include one or more input/output devices 1906 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network management devices, network management entities, clients, gateways, nodes, agents, controllers, computers, cloud based servers, web servers, proxies or proxy servers, application servers, load balancers or load balancing servers, device management servers, or the like. As discussed later, such existing hardware may include, inter alia, one or more Central Processing Units (CPUs), system-on-chip (SOC) devices, digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium”, “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

The terms “including” and/or “having”, as used herein, are defined as comprising (i.e., open language). The term “coupled”, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network management devices, network management entities, clients, gateways, nodes, agents controllers, computers, cloud based servers, web servers, application servers, proxies or proxy servers, load balancers or load balancing servers, device management servers, or the like, may be (or include) hardware, firmware, hardware executing software or any combination thereof. Such hardware may include one or more Central Processing Units (CPUs), system-on-chip (SOC) devices, digital signal processors (DSPs), application-specific-integrated-circuits (ASICs), field programmable gate arrays (FPGAs) computers or the like configured as special purpose machines to perform the functions described herein as well as any other well-known functions of these elements. In at least some cases, CPUs, SOCs, DSPs, ASICs and FPGAs may generally be referred to as processing circuits, processors and/or microprocessors.

The network management devices, network management entities, IOT devices, clients, gateways, nodes, agents, controllers, computers, cloud based servers, web servers, application servers, proxies or proxy servers, load balancers or load balancing servers, device management servers, or the like, may also include various interfaces including one or more transmitters/receivers connected to one or more antennas, a computer readable medium, and (optionally) a display device. The one or more interfaces may be configured to transmit/receive (wireline and/or wirelessly) data or control signals via respective data and control planes or interfaces to/from one or more network elements, such as switches, gateways, termination nodes, controllers, servers, clients, and the like.

Benefits, other advantages, and solutions to problems have been described above with regard to specific embodiments of the invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

Reference is made in detail to embodiments, examples of which are illustrated in the accompanying drawings, wherein like reference numerals refer to the like elements throughout. In this regard, the example embodiments may have different forms and should not be construed as being limited to the descriptions set forth herein. Accordingly, the example embodiments are merely described below, by referring to the figures, to explain example embodiments of the present description. Aspects of various embodiments are specified in the claims.

1. A method for generating alarm notifications in a network, the method comprising:
identifying a stateful alarm object instance linked to a primitive event from a network device of a first type, the stateful alarm object instance based on an alarm configuration for an alarm type associated with the network device of a first type;
determining, based directly on the primitive event, that the primitive event results in a state transition in a state machine for the stateful alarm object instance linked to the primitive event from the network device of a first type;
deciding whether to generate an alarm in response to the state transition; and
selectively generating the alarm based on the deciding step.

2. The method of claim 1, wherein
the primitive event is indicative of a fault event at the network device of a first type, and
the alarm triggers resolving of the fault event.

3. The method of claim 1, wherein the deciding step comprises:
determining that the alarm type is externally visible based on the alarm configuration;
determining that the stateful alarm object instance does not include a delay; and wherein
the selectively generating generates the alarm in response to determining that the alarm type is externally visible and that the stateful alarm object instance does not include a delay.

4. The method of claim 1, wherein the identifying step comprises:
parsing the primitive event received from the network device of a first type to identify the stateful alarm object instance linked to the primitive event.

5. The method of claim 1, further comprising:
recording the primitive event and result of the state transition in an alarm log.

6. A network device to generate alarm notifications in a network, the network device comprising:
at least one processor; and
at least one memory including computer program code, the at least one memory and the computer program code configured to, with the at least one processor, cause the network device to
identify a stateful alarm object instance linked to a primitive event from a network device of a first type, the stateful alarm object instance based on an alarm configuration for an alarm type associated with the network device of a first type,
determine, based directly on the primitive event, that the primitive event results in a state transition in a state machine for the stateful alarm object instance linked to the primitive event from the network device of a first type,
decide whether to generate an alarm in response to the state transition, and
selectively generate the alarm based on the deciding step.

7. The network device of claim 6, wherein
the primitive event is indicative of a fault event at the network device of a first type, and
the alarm triggers resolving of the fault event.

8. The network device of claim 6, wherein the at least one memory and the computer program code are configured to, with the at least one processor, cause the network device to
decide whether to generate the alarm in response to the state transition by
determining that the alarm type is externally visible based on the alarm configuration, and
determining that the stateful alarm object instance does not include a delay, and
generate the alarm in response to determining that the alarm type is externally visible and that the stateful alarm object instance does not include a delay.

9. The network device of claim 6, wherein the at least one memory and the computer program code are configured to, with the at least one processor, cause the network device to parse the primitive event received from the network device to identify the stateful alarm object instance linked to the primitive event.

10. The network device of claim 6, wherein the at least one memory and the computer program code are configured to, with the at least one processor, cause the network device to record the primitive event and result of the state transition in an alarm log in the memory.

11. A non-transitory computer-readable storage medium storing computer-readable instructions that, when executed by at least one processor at a network device, cause the network device to perform a method for generating alarm notifications in a network, the method comprising:
identifying a stateful alarm object instance linked to a primitive event from a network device of a first type, the stateful alarm object instance based on an alarm configuration for an alarm type associated with the network device of a first type;
determining, based directly on the primitive event, that the primitive event results in a state transition in a state machine for the stateful alarm object instance linked to the primitive event from the network device of a first type;
deciding whether to generate an alarm in response to the state transition; and
selectively generating the alarm based on the deciding step.

12. The non-transitory computer-readable storage medium of claim 11, wherein
the primitive event is indicative of a fault event at the network device of a first type, and
the alarm triggers resolving of the fault event.

13. The non-transitory computer-readable storage medium of claim 11, wherein the deciding step comprises:
determining that the alarm type is externally visible based on the alarm configuration;
determining that the stateful alarm object instance does not include a delay; and wherein
the selectively generating generates the alarm in response to determining that the alarm type is externally visible and that the stateful alarm object instance does not include a delay.

14. The non-transitory computer-readable storage medium of claim 11, wherein the identifying comprises: parsing the primitive event received from the network device of a first type to identify the stateful alarm object instance linked to the primitive event.

15. The non-transitory computer-readable storage medium of claim 11, wherein the method further comprises:
recording the primitive event and result of the state transition in an alarm log.

16. A method for generating alarm notifications in a network, the method comprising:
identifying a stateful alarm object instance linked to other stateful alarm object instances for a network device of a first type in response to a received state transition notification event;
determining that the received state transition notification event results in a state transition in a state machine for the network device of a first type, the determining based directly on the received state transition notification event;
deciding whether to generate an alarm in response to the state transition; and
selectively generating the alarm based on the deciding step.

17. The method of claim 16, wherein
the received state transition notification event is indicative of at least one fault event at the network device of a first type, and
the alarm triggers resolving of the at least one fault event.

18. A method for configuring a device to identify alarm conditions at devices in a network, the method comprising:
obtaining a set of network entity instances from a network data store based on network entity types specified in an alarm configuration for a first network device type;
instantiating, in a memory, a stateful alarm object instance for each network entity instance in the set of network entity instances;
listening for primitive events from network devices in the network;
deciding whether to generate an alarm directly in response to a primitive event from a network device based on a stateful alarm object instance for a corresponding network entity instance in the set of network entity instances; and
selectively generating the alarm based on the deciding step.

19. The method of claim 18, further comprising:
generating the alarm configuration for the first network device type; and
loading the alarm configuration for the first network device type onto the device.

20. The method of claim 18,
wherein
the primitive event is indicative of a fault event at the network device of a first type, and
the alarm triggers resolving of the fault event.
